(19) United States
(12) Patent Application Publication
(10) Pub. No.: US 2009/0177553 A1
(43) Pub. Date: Jul. 9, 2009

(54) INTUITIVE TRADING SYSTEM AND INTERFACE

(75) Inventors: Jeremy R. Short, Upland, CA (US); Peter C. Nannis, Dana Point, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TradeMaven Group LLC, Chicago, IL (US)

(21) Appl. No.: 11/995,914

(22) PCT Filed: Jul. 14, 2006
(86) PCT No.: PCT/US06/27332

§ 371 Date: Sep. 29, 2008

Related U.S. Application Data
(60) Provisional application No. 60/700,432, filed on Jul. 19, 2005.

(51) Int. Cl. G06Q 40/00; G06F 3/048

(52) U.S. Cl. 705/26; 705/37; 715/764; 715/856; 715/769; 715/835

(57) ABSTRACT

A system and user interface for commodity trading allows trading on a historical chart or depth of market display. In an embodiment of the invention, the user interface allows the definition and invocation of order strategies to take order actions based on predefined criteria. In an embodiment of the invention order strategies may be multi-layered.

### CROSS-REFERENCE TO RELATED APPLICATIONS

This patent application claims the benefit of U.S. Provisional Patent Application No. 60/700,432 which was filed Jul. 19, 2005.

### FIELD OF INVENTION

The present invention is directed to the trading of a commodity via an electronic exchange. Specifically, the invention provides the trader with an efficient and versatile tool for executing trades.

### BACKGROUND OF THE INVENTION

In order to plan and place a trade, a market trader generally looks at a chart of the price action to gain insight as to what happened and then makes inferences as to what may happen in the future. This is type of chart interpretation and study is commonly referred to technical analysis. Conducting technical analysis typically takes a large amount of time, and may be performed via a user interface of a computing device displaying the appropriate data. The average trader spends a good deal of time conducting technical analysis. After or during the analysis stage, the trader may wish to place a trade as a result of the analysis. Typically, the trader will need to reference a different user interface in order to place such a trade, resulting in screen in clutter, inefficiency, and potential confusion.

The historical data may be presented via a long term historical chart, but an alternative data presentation is a depth of market tabular representation. This interface as well can create certain inefficiencies and confusion depending upon the way in which the presented information is managed and arranged.

Finally, the trade activity that the trader wants to implement may actually be a complex series of trades and other activities. The user interfaces used for analyzing market data and placing trades typically does not allow a user to efficiently implement complex order strategies.

### BRIEF SUMMARY OF THE INVENTION

The invention provides intuitive trading interfaces that combine the presentation of data with the ability to efficiently place orders and implement complex order strategies. In an embodiment of the invention, the user is enabled to place a trade through a data chart or table being used for technical analysis, so that the user need not switch to a different program or window to place a trade. This arrangement significantly decreases order entry errors by having less steps required to analyze historical price of a commodity, then place a trade.

For the average trader, it is significantly easier to manage their position from the screen they are focusing on the most, as apposed to switching to another. There are fewer screens to consider and manage in order to analyze and place a trade on a market which almost always ensures a better trade and often with a better fill price.

### BRIEF DESCRIPTION OF THE SEVERAL VIEWS OF THE DRAWINGS

FIG. 1 is a schematic illustration of an exemplary computing and networking architecture usable within an embodiment of the invention;

FIG. 2 is a schematic view of a chart interface according to an embodiment of the invention;

FIG. 3 is a schematic view of a depth of market interface according to an embodiment of the invention;

FIG. 4 is a example tool area for use in an interface according to an embodiment of the invention;

FIG. 5 is a further example tool area for use in an interface according to an embodiment of the invention;

FIG. 6 is a schematic view of a chart interface according to an embodiment of the invention showing a number of orders;

FIG. 7 is a further schematic view of a chart interface according to an embodiment of the invention showing a number of orders;

FIG. 8 is a schematic view of a chart interface according to an embodiment of the invention showing a mechanism for modifying orders;

FIG. 9 is a schematic view of a chart interface according to an embodiment of the invention showing a mechanism for placing orders;

FIG. 10 is a schematic view of a chart interface according to an embodiment of the invention showing a mechanism for selecting view options;

FIG. 11 is a schematic view of a portion of a chart interface according to an embodiment of the invention showing a strategy invocation area;

FIG. 12 is a schematic view of two sequential chart interfaces according to an embodiment of the invention showing a mechanism for modifying the time scale;

FIG. 13 is a schematic view of two sequential chart interfaces according to an embodiment of the invention showing a mechanism for modifying the price scale;

FIG. 14A is a schematic view of a chart interface according to an embodiment of the invention showing a mechanism for invoking drawing facilities;

FIG. 14B is a schematic view of a user interface according to an embodiment of the invention for creating drawings on a chart;

FIG. 15 is a schematic view of a depth of market interface according to an embodiment of the invention showing a mechanism for modifying orders;

FIG. 16 is a schematic view of a depth of market interface according to an embodiment of the invention showing a depth of market data presentation;

FIG. 17 is a schematic diagram of a user interface according to an embodiment of the invention for creating an order strategy; and

FIG. 18 is a schematic diagram of a further user interface for creating an order strategy according to an embodiment of the invention.

### DETAILED DESCRIPTION OF EMBODIMENTS OF THE INVENTION

The invention provides intuitive trading interfaces that combine the presentation of data with the ability to efficiently place orders and implement complex order strategies. In an embodiment of the invention, a data chart or table is used both to convey market information and to place a trade. This arrangement significantly decreases order entry errors by requiring fewer steps to analyze the historical and real-time price of a commodity, then place a trade. The arrangement of the user interface in embodiments of the invention is configured to facilitate intuitive visual manipulation as will become apparent hereinafter.

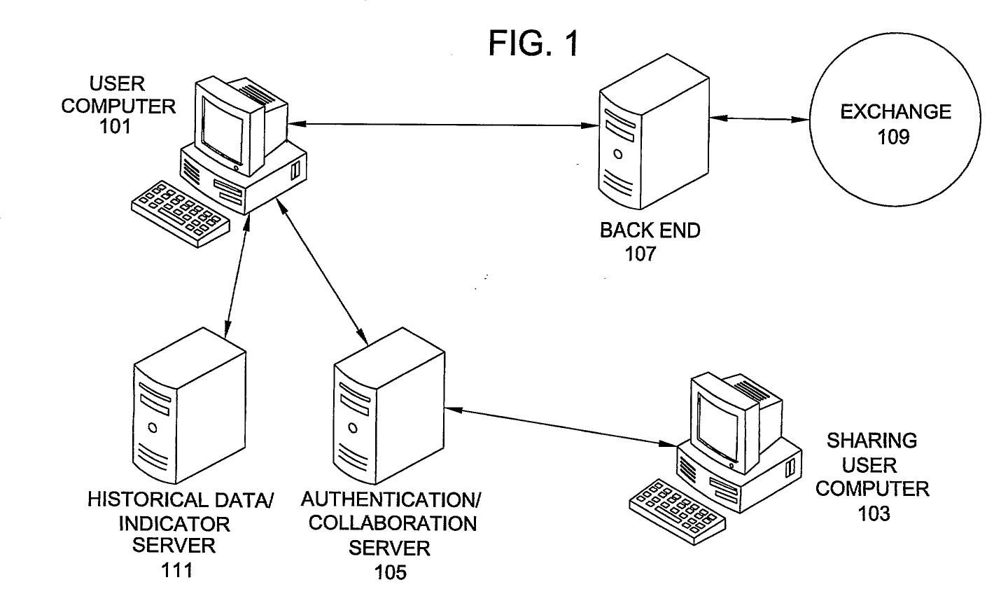

The system according to embodiments of the invention operates in a network environment such as, but not limited to, the environment shown in FIG. 1. A user computer 101 connects via any suitable network connection (Internet and/or LAN, etc.) to a trading backend 107. The trading back end 107 in turn is connected to an exchange 109. In operation, the user computer 101 interfaces with the backend 107 to cause it to execute trades on the exchange 109. In addition, the software executing the described system on the user computer 101 may also be connected in an embodiment of the invention via any suitable connection to an authentication collaboration/educator server 105. Although this description speaks of certain machines performing certain functions, it will be appreciated that, for example, the functions of authentication, collaboration support, and education may be served by one server or multiple servers depending upon designer preferences.

The server 105 acts to authorize the user to operate all or some of the software features on the user computer 101, and may in addition supply setting, configuration or other information to the user computer 101. In addition, server 105 assists collaboration of the user with other users. For example, in an embodiment of the invention, the software executing the invention supports a collaboration mode whereby the user of the user computer 101 may share information with and receive information from another user of the software. To this end, in this embodiment of the invention, the user computer 101 is connected via any suitable network connection to another user computer 103 via server 105. In an embodiment of the invention, computer 101 is also linked via any suitable network connection to a historical data/indicator server 111.

As will be discussed later herein, the user is able in certain embodiments of the invention to create order strategies that are capable of being triggered manually or automatically to run and implement a predetermined course of action. Referring to the architecture described above, such strategies may be stored and run remotely (e.g., on a server) in an embodiment of the invention or locally in an alternative embodiment of the invention.

As will be appreciated by those of skill in the art, a third party source of market information is needed to provide current and historical market data. In an embodiment of the invention, the user's computer is interfaced to the third party source electronically via, for example, the network connection discussed above with respect to FIG. 1.

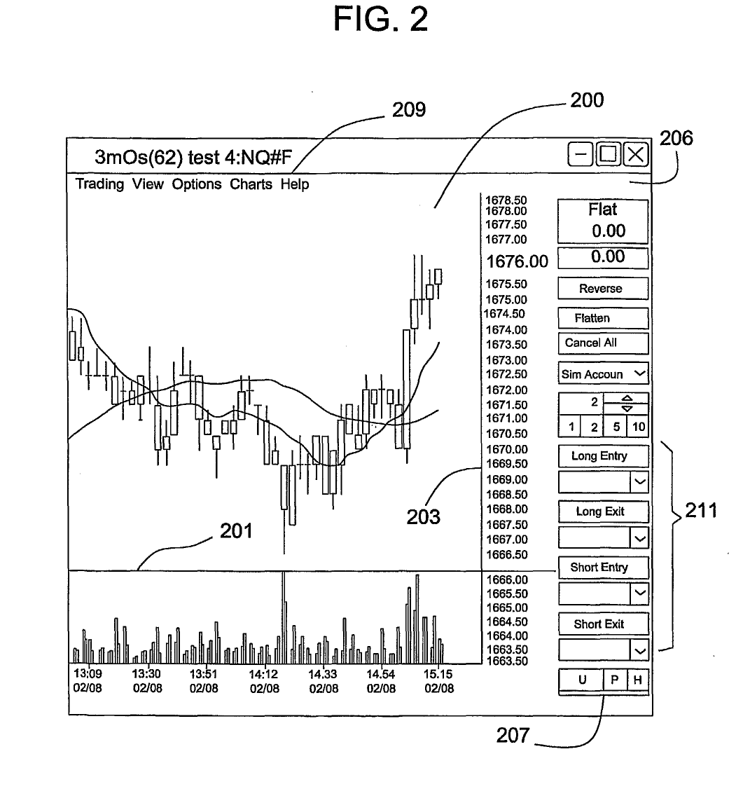

In an embodiment of the invention, an historical price chart 200 such as shown in FIG. 2 is the interface via which the user receives market information and places commodity orders. The price chart 200 has a horizontal axis 201 representing time and a vertical axis 203 representing historical price of the commodity of interest. The chart 200 also comprises a menu area 205 containing one or more drop-down menus 209 and a tool area 207 containing tools for setting trades and invoking strategies. In particular, a plurality of pull-down lists 211 allow the selection of preset or user-defined strategies. Strategies will be discussed in greater detail later.

The tools exposed via the tool area 207 need not be as illustrated but may be any tools selected by the user or designer as most appropriate. In an embodiment of the invention, a full toolbar 400 that contains both direct trade 401 and strategy 403 tools is provided. In an alternative embodiment of the invention, an abbreviated toolbar 500 that omits direct trade tools is used.

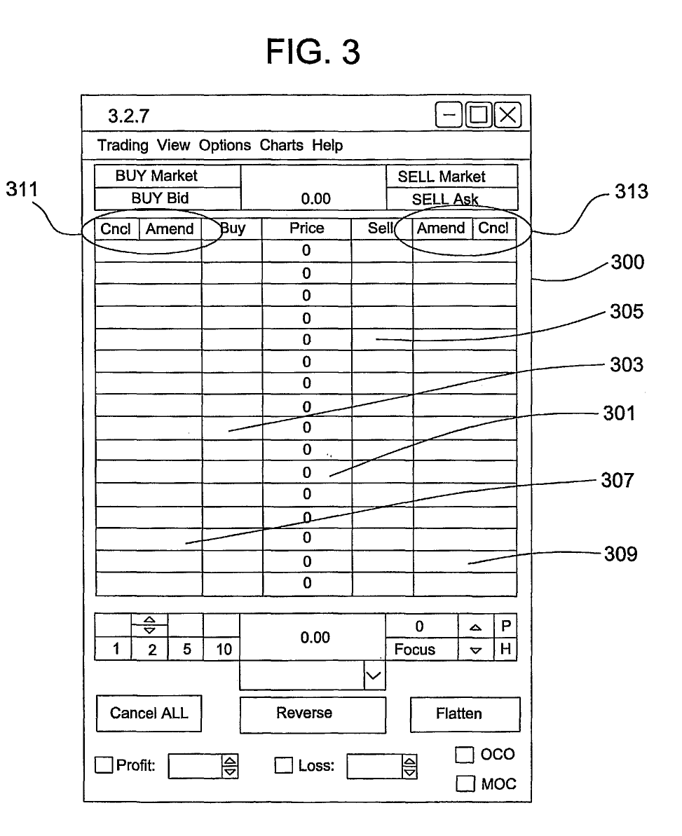

In an another embodiment of the invention, a depth of market price table or ladder 300 such as shown in FIG. 3 is the interface via which the user receives market information and places commodity orders. The depth of market chart 300 contains a number of fields including a price field 301, a buy side depth of market field 303 (“buy field” in “buy column”), and a sell side depth of market field 305 (“sell field” in “sell column”). In addition, the chart 300 includes a buy working order field 307 and a sell working order field 309. By clicking in the buy field 303 or sell field 305 at the desired price level, the user is able to place the appropriate order. The working order fields 307 and 309 allow for amending or cancelling buy side and sell side orders respectively.

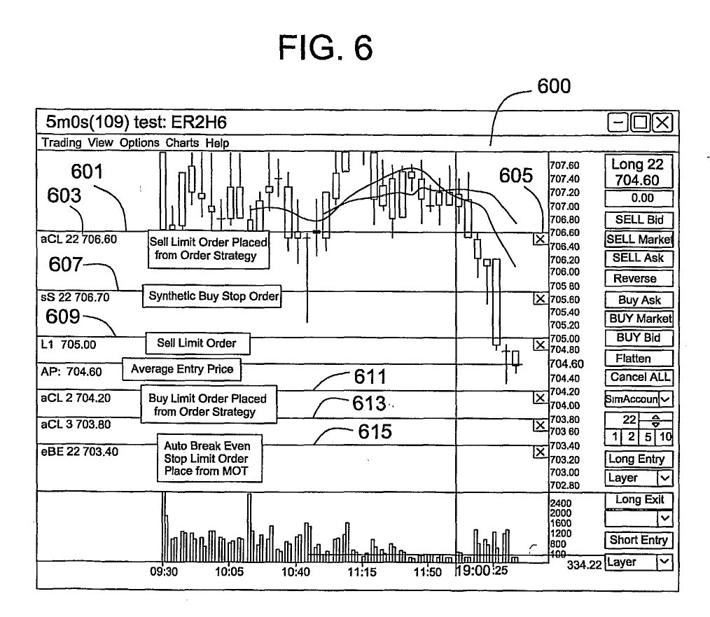

FIG. 6 illustrates the manner in which different order types can be displayed on the chart 600 in an embodiment of the invention. In particular, a first horizontal line 601 represents a sell limit order placed from an order strategy. Note that for each of the order lines shown in this Figure, the descriptive text in large box on line 601 is provided for user convenience and need not be part of the actual user interface. Each line representing an order contains order information such as order type, size and price in the information box 603. In addition, each line representing an order also contains a cancellation area 605. By selecting the cancellation area 605 the user can cancel the order.

Also illustrated in FIG. 6 are a horizontal lines representing other order types such as a synthetic buy stop order 607, a sell limit order 609, buy limit orders placed via an order strategy 611, 613, and an auto breakeven stop limit order 615. Note that in an embodiment of the invention, a designator within the information area 603 can be used to convey the manner in which the order originated. For example, in lines 603, 611, and 613, the “C” in the order information is used to indicate that the order originated from the invocation of a strategy.

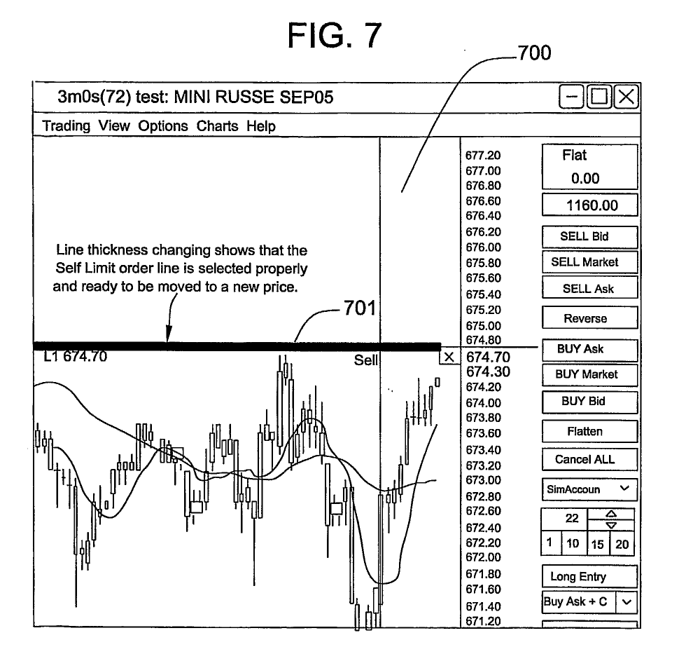

The orders represented in the chart 600 can be cancelled as described above. In addition, the orders can be amended via the chart. For example, by placing the cursor over a line the user is able to left-click and then drag and drop the line at a new price level. In addition to changing the user interface, the order itself is changed to reflect the new price level. Preferably, when the cursor is directly over an order line, the line is visually changed, such as by thickening, to indicate that a mouse action will affect that order. The chart 700 of FIG. 7 illustrates the manner in which an order line 701 thickens when selectable. This is useful when the user is in a mode (another mode will be discussed below) wherein orders can be placed on the chart as described above. In such a mode, clicking in an area that is not already an order will result in the placement of an order rather than the modification of an existing order.

In an embodiment of the invention, when the user interface shows more than one order indication such as order line 701, moving one of the order lines to overlap another order line results in the consolidation of the two order lines into a single order line that nonetheless displays data fields for each of the underlying orders. For example, the single order line may comprise a field for manipulating a first order linked to the first indication and a second field for manipulating a second order linked to the second indication and a data field (for example, showing price) for each underlying order. Thus, the underlying orders may still be understood and manipulated, but the user interface remains uncluttered.

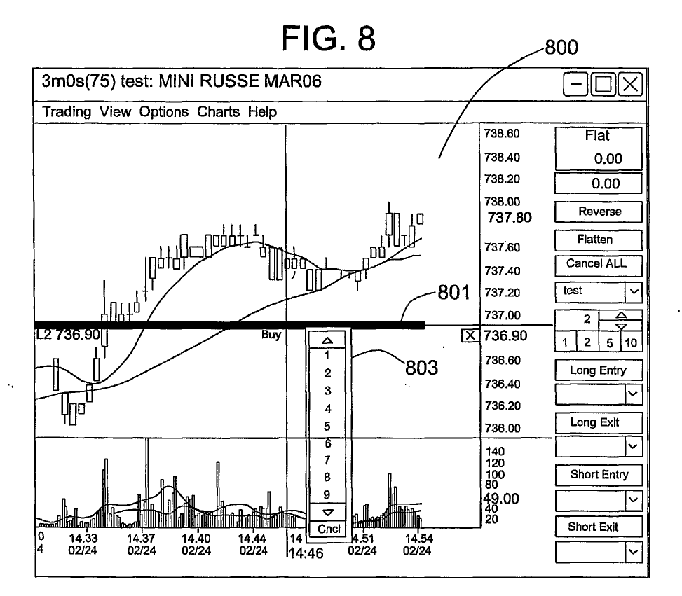

Moreover, in an embodiment of the invention, the user may right-click on an order line to open a display of selectable options for modifying the order. For example, the chart 800 of FIG. 8 illustrates that in an embodiment of the invention, when an order line 801 is right-clicked, a pull-down menu 803 of options is presented via the user interface. In the illustrated embodiment of the invention, the options include selectable lot sizes to change the lot size as well as a cancellation option. In an embodiment of the invention, the cancellation option is selectable to close the pull-down menu 803. However, in an alternative embodiment of the invention, the cancellation option is selectable to cancel the associated order.

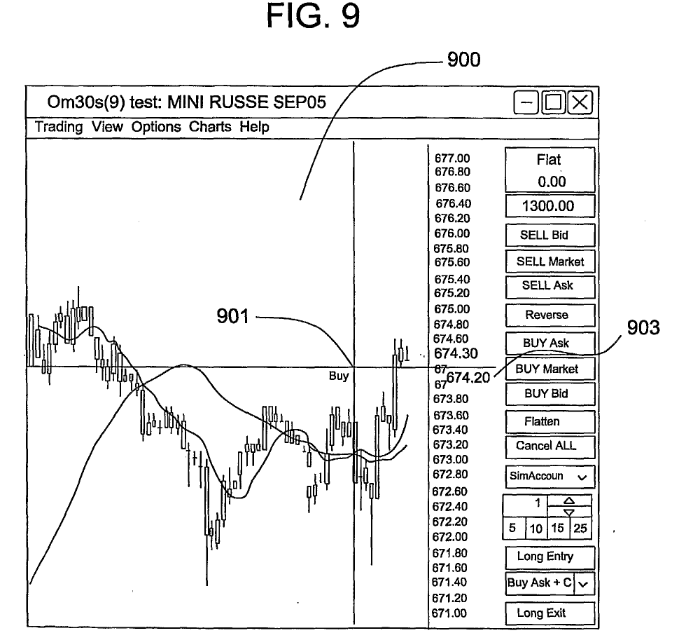

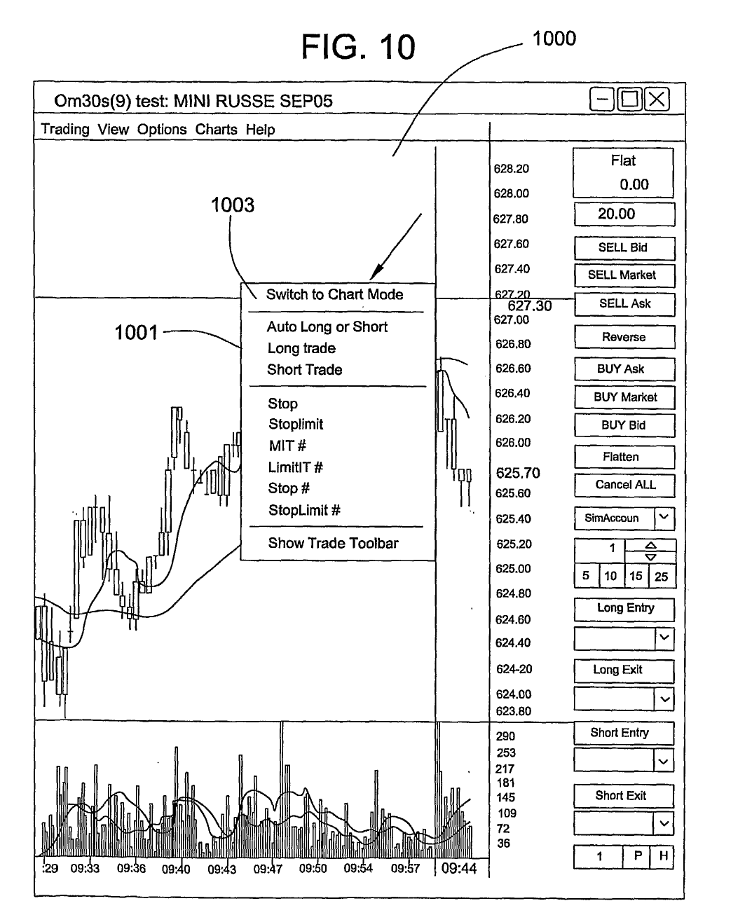

FIG. 9 illustrates the manner in which an order can be placed on the chart 900 according to an embodiment of the invention. In particular, the cursor is represented by a cross-hair 901 that indicates the price level at which an order will be placed if the user left-clicks. In an embodiment of the invention, the cross-hair 901 also includes a numerical price indicator 903. In an embodiment of the invention, the location of the cursor when the left-click occurs is used by the application to determine whether the order is a buy order or a sell order. The parameters of the order can be preset by the user via the user interface. For example, the user may preset the lot size of the order and the order type. In an embodiment of the invention, the interface presents a visual indication, such as via a color of the cross-hair, etc., of the status of a potential order action prior to user left-clicking the mouse, so that the user knows what order action that will be taken if he or she left-clicks.

As noted above, in an embodiment of the invention two modes are provided, one being a “safe” or “chart” mode, and the other being a “trade” mode. The safe mode allows the user to click on the chart without the risk of placing an order, while the trade mod allows the placement of orders as discussed above. In embodiment of the invention, a menu 1001 is presented when the user right-clicks on an area of the chart 1001 where there is no order. The menu 1001 may contain multiple selectable options, but in an embodiment of the invention, the menu presents a selectable option 1003 to switch the mode of the chart. In the illustrated Figure, the chart is currently in trade mode and the menu 1001 presents a selectable option 1003 to switch to chart mode. The user selects the option in an embodiment of the invention by left-clicking on it. However, in an embodiment of the invention, the functions performed upon left click and right respectively are user-customizable.

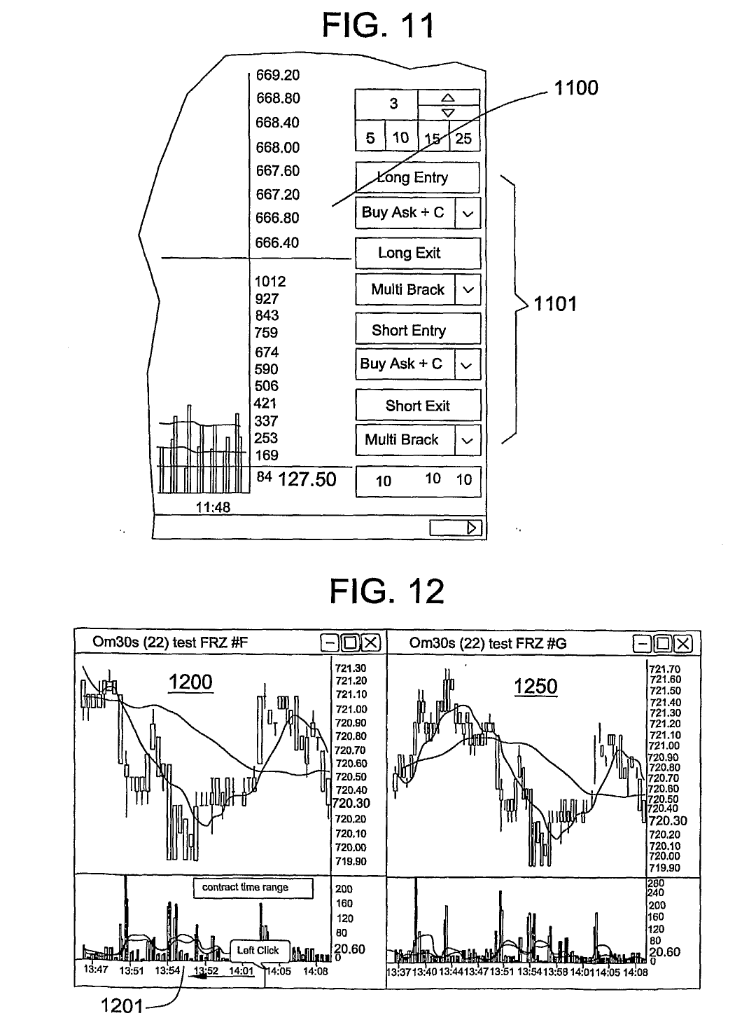

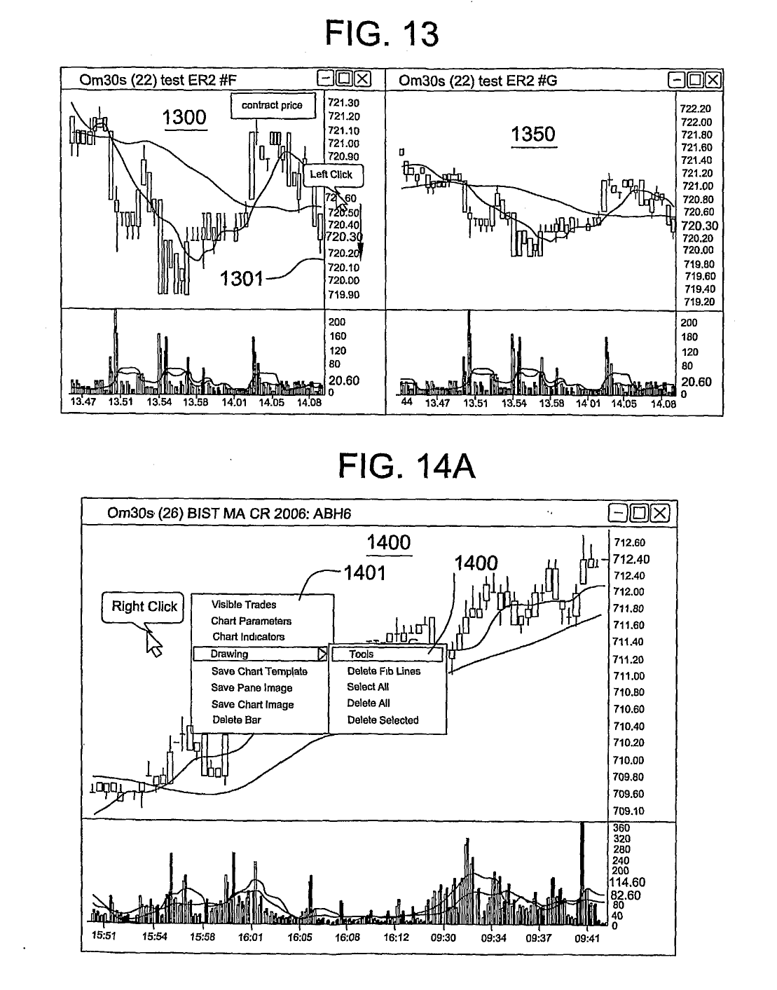

FIG. 11 illustrates in greater detail a strategy selection area of the chart interface. Strategies allow a user to quickly place one or more orders by simply invoking the strategies. Strategies typically are divided into Long and Short Entry strategies and Long and Short Exit strategies. In the illustrated interface 1100 according to an embodiment of the invention, a tool bar portion 1101 of the interface presents selectable pull-down menus for Long and Short Entry strategies and Long and Short Exit strategies. The option presented upon selection of these items may include predefined strategies defined by the producer of the interface. In an embodiment of the invention, the items also include user-defined strategies. The manner in which these can be created will be discussed later. It should be noted that the invocation of a strategy may not result in an order being placed, cancelled or modified immediately. In an embodiment of the invention, some strategies are defined to trigger upon the occurrence of a triggering event such as a specified price level being reached.

The axes of the chart are manipulable by the user in an embodiment of the invention. FIG. 12 illustrates the manner in which the user can contract the horizontal time axis of the chart 1200. The user first clicks in the chart 1200 on the time axis 1201. Then, while holding down the mouse key, the user drags the cursor toward the origin. When the mouse key is released, the time axis resizes as shown in chart 1250. The user may reverse the process (i.e., click and drag a portion of the axis away from the origin) to expand the time axis 1201.

Similarly, the user can manipulate the vertical price axis in order to see more or less of the price range. In particular, the user first clicks in the chart 1300 on the price axis 1301. Then, while holding down the mouse key, the user drags the cursor downward. When the mouse key is released, the price axis resizes as shown in chart 1350. As with the time axis, the user may reverse the process (i.e., click and drag a portion of the axis upward) to expand the price axis 1301.

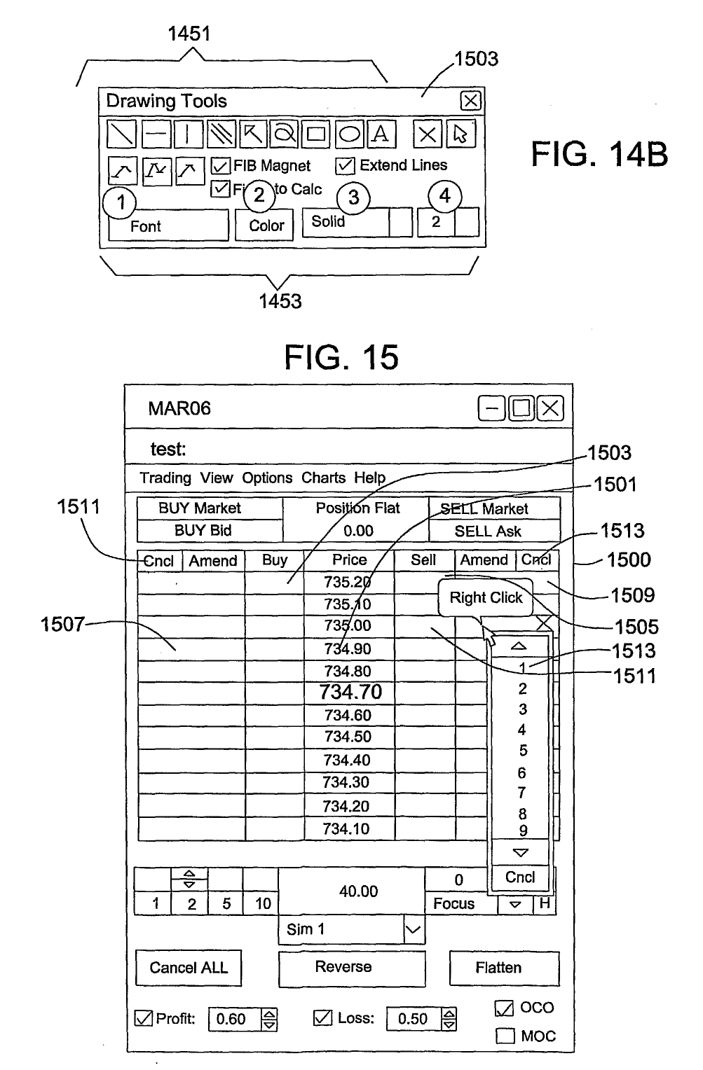

The user interface may also allow the user to draw on the chart. This can be useful for noting trends and other information. As shown in FIG. 14A and as described above, when the user right clicks on a blank area of the chart 1400, a single or multilayer menu 1401 of selectable options is presented. One of the options is a “tools” option 1403. When this menu item is selected by the user, a “drawing tools” window 1450 is displayed to the user as shown in FIG. 14B. The drawing tools window displays one or more selectable options to allow the user to create certain types and/or styles of drawings. The drawing tools window 1450 presents a series of action buttons 1451 selectable by the user to indicate the drawing action to be taken when the cursor is subsequently manipulated. In the illustrated example, the action buttons include buttons for different types of lines and shapes as well as a text button to allow the insertion of text. The drawing tools window 1450 may present a series of style buttons 1453 selectable by the user to indicate the style to be applied to a selected drawing action when the cursor is subsequently manipulated. In the illustrated example, the style buttons include buttons usable to select the color, style (e.g., solid), and thickness (e.g., 2 pt.) of a line (e.g., as such or as part of a shape) to be drawn and a button usable to select the font of text to be inserted.

As discussed above with reference to FIG. 3, embodiments of the invention also allow the user to interact with the market via a depth of market display such as shown in FIG. 3. In overview, as will be discussed in greater detail, the trade window includes a price column, a buy column, a sell column, a bid working order column and an ask working order column (amend/cancellation columns). When the mouse cursor is not in the buy or sell quantity columns or the amend/cancellation columns, then in the price column, when the display is updated, the best ask price remains vertically centered in the price column in an embodiment of the invention. When the best ask price changes, the price displayed in the center cell is changed to reflect the new best ask price and the prices displayed in the other cells are also correspondingly changed to reflect the change to the displayed range of prices. In addition, the cells of the buy and sell columns and the amend/cancellation columns are also adjusted so that the bid and ask quantities remain aligned with the appropriate corresponding price and the cells of the working order columns remain aligned with the appropriate corresponding price.

When the mouse cursor is moved into any part of the quantity columns or the working order columns, the screen enters a trade mode and the quantity columns immediately stop displaying any quantities. The price column becomes static and the last traded price is highlighted. As will be discussed in greater detail, a user can enter an order by clicking in either the buy column or sell column. In an embodiment of the invention, the trade window allows the user to amend or cancel working orders by clicking or dragging and dropping within the working order column. When the screen is in the trade mode, the screen does not display any data in the buy and/or sell quantity columns and does not display any indicator associated with orders to buy or sell relative to the price column (other than working orders). When the cursor moves outside of the buy/sell and amend/cancel columns, the screen returns to the view mode and the price ladder is again centered.

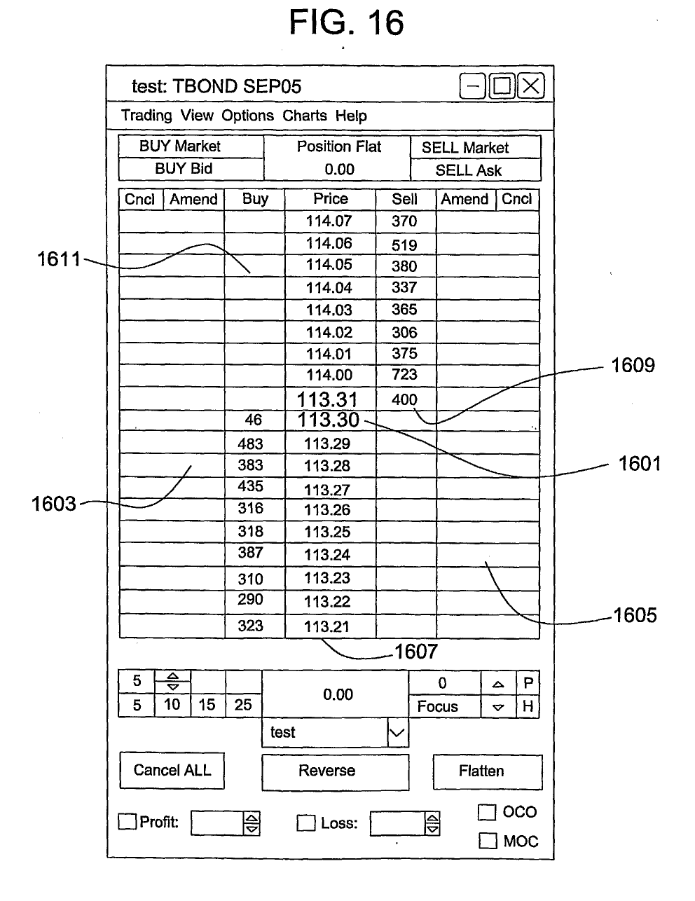

FIG. 15 shows such an interface as well as certain features provided by embodiments of the invention. In particular, the chart 1500 further includes fields 1507 and 1509 for amending or cancelling buy side and sell side orders respectively. The market depth fields 1503 and 1505 (i.e., buy and sell columns respectively) normally display the market depth data, e.g., pending orders. However, during the placement of an order, the display of market depth data can be distracting. Moreover, those of skill in the art will appreciate that the market depth data can be manipulated by others in the market. To minimize problems due to distraction and to remind the user that the depth of market data is not entirely reliable, the depth of market data is not shown when the cursor is in either of the order fields 1503, 1505, or the working order fields 1507, 1509. However, when the cursor is elsewhere, the depth of market data is shown (see, for example, FIG. 16).

FIG. 15 further illustrates a mechanism for modifying an order. The chart 1500 of FIG. 15 illustrates that in an embodiment of the invention, when an order 1511 is right-clicked, a pull-down menu 1513 of options is presented via the user interface. In the illustrated embodiment of the invention, the options include selectable lot sizes to change the lot size as well as a cancellation option, discussed in more detail with respect to FIG. 8 above.

FIG. 16 illustrates an autocenter option usable with a depth of market data such as described above. When the auto center option is engaged as in FIG. 16, the last traded price 1601 remains visible and substantially centered on the user interface 1600. In this mode, when the cursor is not in a buy or sell field 1611, 1613, the depth of market data 1607, 1609 is displayed as well. Conversely, as discussed above, when the cursor is located in a buy or sell field 1611, 1613, the depth of market data 1607, 1609 is removed from the interface. In addition, when the cursor is located in a working order field 1603, 1605 or a buy or sell field 1611, 1613, the last traded price 1601 no longer necessarily remains visible and centered, and instead the interface maintains the selected price level in the relevant order column centered.

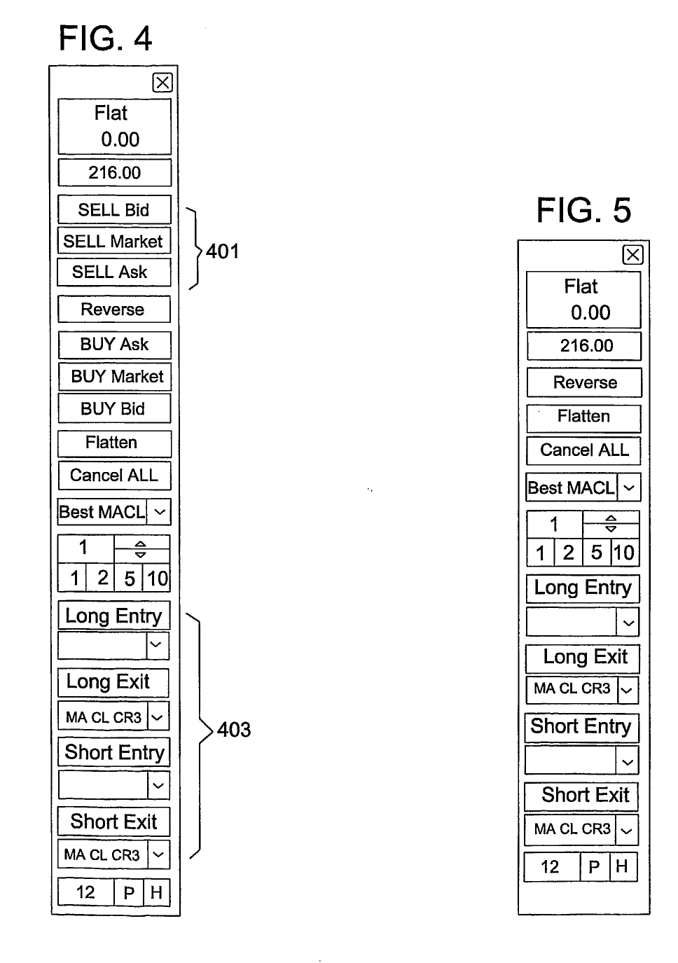

Whether the selected user interface is a chart as in FIG. 2 or a depth of market display as in FIG. 3, the interface includes, in an embodiment of the invention, a tool area associated with and, in an embodiment of the invention connected to, the chart or display. FIGS. 4 and 5 and the accompanying description describe example tool areas.

As discussed above, rather than placing orders on a direct and individual basis, a user may invoke default or user-predefined order strategies. The mechanisms for involving such strategies are discussed elsewhere herein, but the following discussion illustrates exemplary mechanisms for defining such strategies.

Before discussing the details of the interface, a functional overview will be given. An order strategy comprises a parent layer and may also comprise one or more child layers. A child layer fires when an order placed pursuant to the parent layer meets user-defined criteria. The number of strategy layers is not limited in principle, and may comprise many subsequent layers of child strategies, each firing off of an action caused by its immediate parent strategy when appropriate. Order strategies can comprise entry strategies (e.g., to enter a market position) and/or exit strategies (e.g., to exit a market position). As a result, in an embodiment of the invention, the order strategy type is used to determine whether an order placed pursuant to the strategy is placed as a buy or sell order. As an example, when an order strategy comprises at least in part a market entry strategy, and the order strategy comprises criteria and preset parameters, when the specified one or more criteria are met, one or more orders are placed pursuant to the strategy in keeping with the preset parameters. Similarly, when the order strategy includes a market exit strategy having criteria and preset parameters, when the specified one or more criteria are met, at least one order pursuant to the strategy is placed in keeping with the preset parameters.

Preset parameters may comprise, for example, a lot size, which may be fixed or dynamic. The criteria of interest are user-settable, but an exemplary gauge or criterion is a price criterion reflective of a price at which the order is placed. In more general terms, criteria can include, for example, market size, order type, static or dynamic reference price, and static or dynamic (and positive or negative) tick offsets.

It should be noted that in an embodiment of the invention, the order strategy comprises an algorithm to determine if an order is to be placed as a buy or sell order. In this manner, whether the order is a buy or sell is not and need not be predetermined by a user, allowing flexibility, adaptability, and ease of use. Nonetheless, the order strategy can still also comprise specific instructions to place an order as one of a buy and sell order as discussed above. Of course, the order strategy can also comprise instructions for the cancellation of an order.

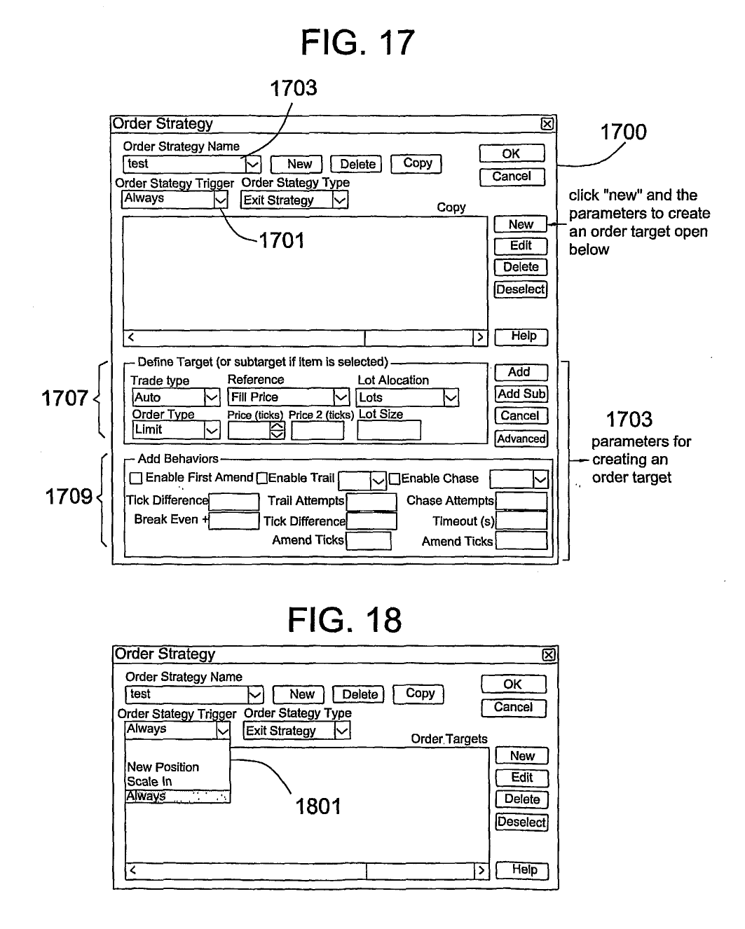

FIG. 17 illustrates an order strategy window for defining order strategies. The window 1700 can be invoked from either a chart or depth of market interface, such as via a selectable icon or menu item. Once the order strategy window is opened, the user is able to use it to define strategies, including single-layer strategies or multilayer strategies. In general, a strategy includes a trigger, used to determine when to execute the strategy, as well as one or more actions to be taken when the strategy is executed. The order strategy trigger may be selected in an embodiment of the invention via a strategy trigger pull-down menu 1701. Available triggers can be of any suitable type. In an embodiment of the invention available triggers include “new position,” “scale in,” and “always” as shown in FIG. 18, element 1801. The “new position” trigger invokes the defined strategy when the user gets a fill while flat with no current position. It will not trigger if the user is already in a long or short position. The “scale in” position trigger invokes the defined strategy when the user gets a fill while long or short but will not trigger when the user's position is flat when filled. The “always” trigger invokes the defined strategy when the user gets a fill while long, short, or flat. The user can also define custom triggers. The user can name the strategy via an Order Strategy Name menu 1703, wherein the user can either select a predefined name or create a new name.

As discussed above, an order strategy is used to execute defined actions when the trigger event occurs. The Order Strategy window 1700 allows the user to define the strategy via a series of selectable options and fillable fields as illustrated in section 1705 of interface 1700. As shown, section 1705 includes a subsection 1707 that allows the user to define the target in terms of trade type, order type, price, lot size, and other parameters. Section 1705 also includes a subsection 1709 that allows the user to add additional behaviors to the strategy.

Further details of interest regarding the system described herein can be found in the “Getting Started With TradeMaven” manual, available on and prior to Jul. 14, 2006, the Trade Maven “Sample Strategies” manual of the same date, the TradeMaven “Strategy Builder” manual, version 3 (January 2006), and the “TradeMaven Standard Version” manual (3.2.9, March 2006), all of which are archived by and available from TradeMaven Group LLC, Chicago Board of Trade Building, 141 W. Jackson Blvd. Suite 1080, Chicago, Ill. 60604, and which in the interest of brevity are each herein incorporated by reference at this point in the text in their entirety without exclusion of any portion thereof.

It will be appreciated that a new and useful system for commodity trading has been described herein. Preferred embodiments of this invention are described herein, including the best mode known to the inventors for carrying out the claimed invention. Variations of these preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A method of executing the placement, modification, or cancellation of an order for a tradable commodity in an electronic exchange via a computer user interface comprising:
displaying to the user a chronological chart of a price of a commodity of interest, the chart displaying a current price and a plurality of past prices for the commodity;
receiving on the chart a user action via the computer user interface indicating a desired transaction relative to the commodity of interest; and
executing the desired transaction based on the received user action.

2. The method according to claim 1, further comprising:
receiving a mode change user action via the computer user interface to indicate a change of mode of the user interface; and
in response to receiving the mode change user action, changing the mode of the user interface to a safe mode whereby user actions with respect to the user interface cannot result in execution of a trade placement, but still allows modification, or cancellation of working orders.

3. The method according to claim 2, wherein the user interface, while in safe mode, exposes a selectable option to the user whereby a user selection of the option in the user interface reverts the mode of the user interface so that user actions with respect to the user interface can result in execution of a trade placement.

4. The method according to claim 3, wherein the selectable option is accessed via an option button of a cursor-controlling device, and selected via a selection button of the cursor-controlling device.

5. The method according to claim 1, wherein the received user action is a click of mouse button, and wherein the desired transaction is a buy or sell order, and wherein a location of a cursor associated with the mouse when the click is received determines the price at which to place the order.

6. The method according to claim 5, wherein the location of the cursor associated with the mouse when the click is received further determines whether the order is a buy order or a sell order.

7. The method according to claim 5, wherein selected parameters of the order have been preset.

8. The method according to claim 7, wherein the selected parameters comprise the lot size of the order and the order type.

9. The method according to claim 1, wherein the received user action is a click of mouse button, the desired transaction is a cancellation order, and wherein the location of a cursor associated with the mouse when the click is received determines the order to be cancelled.

10. The method according to claim 1, wherein the received user action is a drag and drop operation via a mouse button comprising a mouse click, drag, and release, the desired transaction is an order modification, and wherein the location of a cursor associated with the mouse when the mouse is clicked determines the order to be modified.

11. The method according to claim 1, further comprising presenting a visual indication of the status of a potential order action prior to the step of receiving the user action, wherein the visual indication conveys to the user information about the order action that will be taken if the user action is received while the cursor remains in the present location.

12. The method according to claim 1, further comprising the step of displaying a visual order indication on the user interface corresponding to the desired transaction.

13. The method according to claim 12, wherein the visual order indication comprises a line horizontal with a time axis of the chart at a vertical level that reflects a price relevant to the order.

14. The method according to claim 13, wherein receiving a user action on the visual order indication results in a display of a plurality of details relative to the order.

15. The method according to claim 13, wherein when the user interface shows a plurality of visual order indications, moving one of the plurality of indications to overlap a second of the plurality of the indications results in the consolidation of the first and second indications into a single visual indication displaying multiple fields for conveying one or more aspects of each of the underlying orders.

16. The method according to claim 1, further comprising the step of displaying on a portion of the user interface a tool bar comprising a plurality of selectable areas, at least one of the plurality of selectable areas adapted to perform an entry, modification, or cancellation of an order when selected, and a least one other of the plurality of selectable areas adapted to execute an order strategy when selected.

17. The method according to claim 1, further comprising the step of displaying on a portion of the user interface a tool bar comprising one or more selectable areas, each of the one or more selectable areas adapted to execute an order strategy when selected.

18. A method of implementing an order strategy via a computing device comprising:
presenting to a user of the computing device a strategy definition window, wherein the strategy definition window provides fields for the user to specify a desired order strategy to be implemented if one or more criteria are met, where an order strategy consists of a set of orders and behaviors or criteria;
receiving user input specifying the desired order strategy and specifying the one or more criteria;
saving the specified order strategy and criteria; and
detecting that the one or more criteria have been met and causing the specified order strategy to be executed in response.

19. The method according to claim 18, wherein the step of causing the specified order strategy to be executed further comprises running software to execute the order strategy on a device remote from the computing device.

20. The method according to claim 19, wherein the device remote from the computing device comprises a server.

21. The method of claim 18, wherein the order strategy has a type selected from the group consisting of an entry strategy to enter a market position and an exit strategy to exit a market position.

22. The method of claim 21 wherein the order strategy type determines whether an order placed pursuant to the strategy is placed as a buy or sell order.

23. The method according to claim 18, wherein the desired order strategy comprises at least in part a market entry strategy having preset parameters, whereby when the specified one or more criteria are met, at least one order pursuant to the strategy is placed in keeping with the preset parameters.

24. The method according to claim 23, wherein the one or more criteria comprise a price criteria reflective of a price at which the order is placed.

25. The method according to claim 18, wherein the desired trading strategy comprises at least in part a market exit strategy whereby when the specified one or more criteria are met, at least one order pursuant to the strategy is placed in keeping with the preset parameters.

26. The method according to claim 25, wherein the one or more criteria comprise a price criteria reflective of a price at which the order is placed.

27. The method according to claim 18, wherein the desired order strategy comprises at least in part a subsidiary order strategy having subsidiary criteria and selected order actions, and wherein when one or more subsidiary criteria are met, the method further comprising executing the subsidiary order strategy.

28. The method according to claim 21, wherein the desired order strategy is itself subsidiary to another order strategy.

29. The method according to claim 27, wherein order activity occurs based on criteria selected from the group consisting of market side, order type, reference price, and tick offsets.

30. The method according to claim 18, wherein the desired trading strategy comprises at least in part a lot size and wherein the at least one criteria comprise at least in part a reference price, tick offsets, or market size.

31. The method according to claim 30, wherein the lot size is fixed.

32. The method according to claim 30, wherein the reference price is fixed.

33. The method according to claim 30, wherein the lot size is dynamic.

34. The method according to claim 30, wherein the reference price is dynamic.

35. The method according to claim 30, wherein the desired order strategy comprises at least in part a market side (buy/sell).

36. The method according to claim 35 wherein the order strategy comprises an algorithm to determine if an order is to be placed as a buy or sell order.

37. The method according to claim 35 wherein the order strategy comprises instructions to place an order as one of a buy and sell order.

38. The method according to claim 30, wherein the desired order strategy comprises at least in part the execution of an order cancellation.

39. The method according to claim 30, wherein tick offsets to apply to the reference price are fixed or dynamic and positive or negative.

40. A method of presenting on a display of a computing device a trade interface for allowing a user to enter, manipulate, or view commodity order information via manipulation of a cursor, the trade window comprising a price column, a buy column, a sell column, a bid working order column and an ask working order column, the method comprising:
presenting the user interface in one of a trade mode and a view mode, wherein the user can place a trade via manipulation of the cursor while the interface is in the trade mode, and wherein the user cannot place an order via manipulation of the cursor while the interface is in the view mode;
switching from one of the trade mode and view mode to the other of the trade mode and view mode as a function of the location of the cursor, such that when the cursor is not in the buy, sell or working order columns, the interface is in the view mode and when the cursor is in any of the buy, sell or working order columns, the interface is in the trade mode;
clearing the buy and sell columns so that they do not display any quantities and presenting the price column as static, wherein the last traded price is visually highlighted, when the interface is in the trade mode; and
receiving a user action via a cursor click in one of the buy, sell, and working order columns when the interface is in the trade mode and performing an associated order action.

41. The method according to claim 40, further comprising updating the price column, when the interface is in the view mode, such that a best ask price remains vertically centered in the price column when the best ask price changes.

42. The method according to claim 40, wherein the associated order action consists of amending a working order when the cursor click occurs in a working order column and is part of a drag and drop operation, canceling a working order when the cursor click occurs in a working order column and is not part of a drag and drop operation, placing a buy order when the cursor click occurs in the buy column, and placing a sell order when the cursor click occurs in the sell column.
